(19) United States
(12) Patent Application Publication
(10) Pub. No.: US 2006/0065208 A1
(43) Pub. Date: Mar. 30, 2006

(54) Enclosure with floor panel entrance

(76) Inventor: Jacqueline L. Mooney, Franklin, TN (US)

Correspondence Address: JAMES ADDISON BARRY, JR., 105 GLENWAY POINT, LEBANON, TN, 37087, US

(21) Appl. No.: 11/235,563

(22) Filed: Sep. 26, 2005

Related U.S. Application Data
(60) Provisional application No. 60/613,948, filed on Sep. 28, 2004.

(51) Int. Cl. A01K 1/02

(52) U.S. Cl. 119/485

(57) ABSTRACT

An enclosure with floor panel entrance 100 including a floor panel 118 attached with the lower portion of said enclosure 100; a means to raise said floor panel 118 off the ground to a height that enables a pet to maneuver beneath said floor panel 118; and an aperture 124 disposed in said floor panel 118 by which the pet may access said enclosure 100.

### CROSS-REFERENCE TO RELATED APPLICATIONS

This application claims the benefit of U.S. Provisional Application No. 60/613,948, filed with the U.S. Patent and Trademark Office on Sep. 28, 2004, and titled “Litter Box Housing Cabinet With Floor Panel Entrance.”

### FILED OF THE INVENTION

The present invention relates to an enclosure for pets and pet-related accessories.

### BACKGROUND OF THE INVENTION

There is a need for enclosures that provide containment, seclusion, easy access for animal and consumer, and hide or conceal pet-related articles while in use by the pet.

### BRIEF DESCRIPTION OF THE DRAWINGS

FIG. 1 illustrates a perspective view of one embodiment representing a freestanding cabinet with an aperture in a floor panel of the enclosure.

FIG. 2 illustrates a perspective view of another embodiment representing a built-in cabinet with an aperture in a floor panel of the enclosure.

FIG. 3 illustrates a perspective view of still another embodiment representing a wall within the interior of the enclosure.

FIG. 4 illustrates a bottom view of another embodiment representing bristles encircling the aperture perimeter.

FIG. 5A illustrates a perspective view of yet another embodiment representing a feeding drawer under the enclosure.

FIG. 5B illustrates a side view of another embodiment representing a closed feeding drawer under the enclosure.

FIG. 5C illustrates a perspective view of another embodiment representing an open feeding drawer under the enclosure.

### DETAILED DESCRIPTION

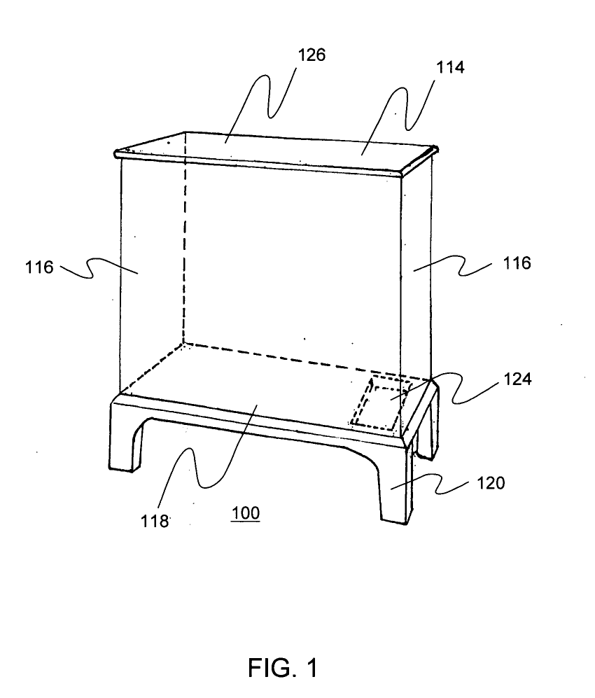

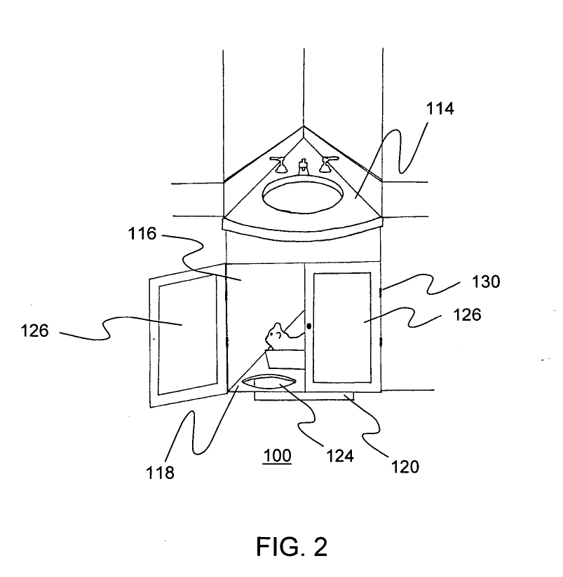

FIG. 1 depicts an enclosure with floor panel entrance 100 that is an operational container that may resemble various types of household furniture, or as shown in FIG. 2 built-in household cabinetry. This enclosure 100 can be incorporated into freestanding cabinetry or installed in built-in cabinetry. A typical application of the freestanding version of this enclosure 100 is to incorporate the enclosure with floor panel entrance 100 into ordinary household furniture, such as a trunk, a dresser, or even a round ottoman constructed with one cabinet panel. A typical application of the built-in version of this enclosure 100 is to incorporate it into ordinary household cabinetry one might find in a laundry room, kitchen, or bathroom. The enclosure's main purpose is to hide or conceal a cat litter box or other pet-related articles while in use by the cat or small animal. The enclosure 100 provides containment, seclusion and easy access for the animal and the consumer.

The enclosure 100 as illustrated in FIGS. 1, 2, and 3 may comprise a top panel 114; one or more side panels 116 that may be disposed on the front, side, or rear portion of the enclosure 100 that are a height which enable a cat or other small animal to move comfortably inside the enclosure or cabinet; and a floor panel 118. The top panel 114 may be a permanent fixture placed atop the side panels as illustrated in one embodiment in FIG. 2. In this embodiment, the cabinet is built into a corner and secured to a wall and the top panel 114 is illustrated as a countertop with bathroom sink. The floor panel 118 may be surrounded by and attached with side panels 116 that form the enclosure or cabinet interior. The cabinet or enclosure 100 is raised off the ground. The means to raise the cabinet off the ground may be furniture legs or a base support structure 120, to raise the floor panel 118 to a height above the floor that enables a pet, cat, or small animal to easily maneuver beneath the floor panel 118. The means to raise the cabinet 100 along with the floor panel 118 off the ground may also be a means of attaching the enclosure 100 to the wall structure of the house or building. The animal enters the cabinet interior beneath the enclosure 100, through a hole, opening, or aperture 124 in the cabinet floor panel 118 that the pet finds when the pet is under the enclosure 100. The aperture 124 is an open area large enough to form an entrance/exit for the pet. Because the entrance/exit is located underneath the cabinet 100, it is concealed from the consumer's view.

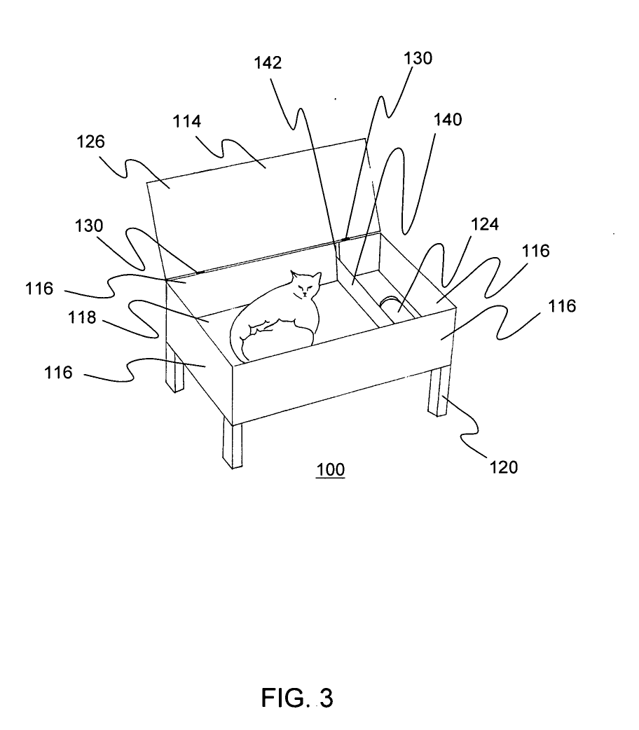

One or more lids or access doors 126 may provide the consumer with access to the cabinet interior as illustrated in FIGS. 1, 2, and 3. The access doors 126 may be hinged 130, attached, or unattached, and positioned or located where the consumer specifies. For example, the access door may be placed on, attached to, or replace the top panel 114 as illustrated in FIG. 3, or it may placed on, attached to, or replace a side panel either in the front, rear, left, or right of the enclosure as illustrated in FIG. 2. The access door 126 is easily removed, opened or closed, to allow the consumer easy access to the inside compartment of the cabinet 100 for cleaning, removal and maintenance of a cat litter box or other pet related products. The enclosure or cabinet 100 is designed to be used by the pet with the access door 126 in the closed position. In FIG. 2, the embodiment illustrates two access doors 126 attached with the front side of the cabinet 100. One door 126 is shown open; the other door 126 is shown closed. A cat/pet occupant is shown in a litter box placed in the interior of the cabinet. The litter box is placed on the floor panel 118, so as not obstruct the entrance/exit.

To train an animal to use the enclosure with floor panel entrance 100, open the access door 126, place the animal inside the cabinet 100 and close the access door 126. The animal will immediately become acquainted with the entrance/exit to the unit. FIG. 2 depicts a cat shown inside a litter box placed on the floor panel 118.

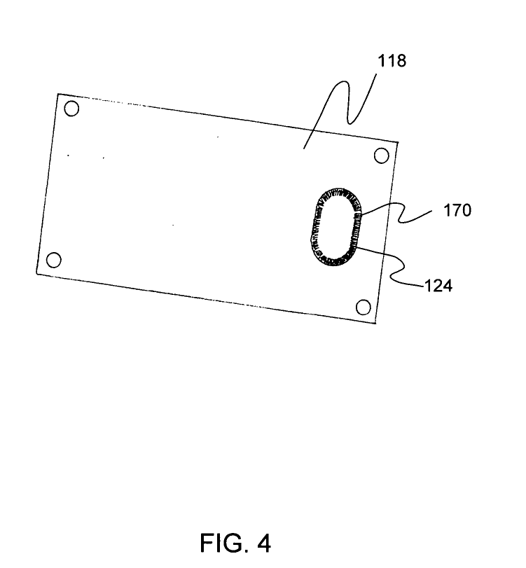

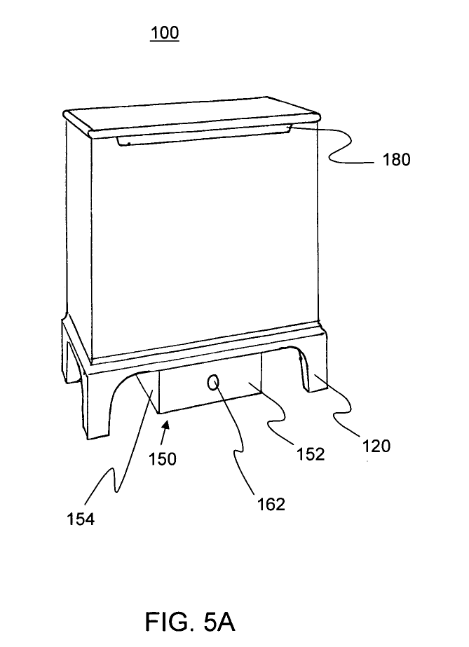

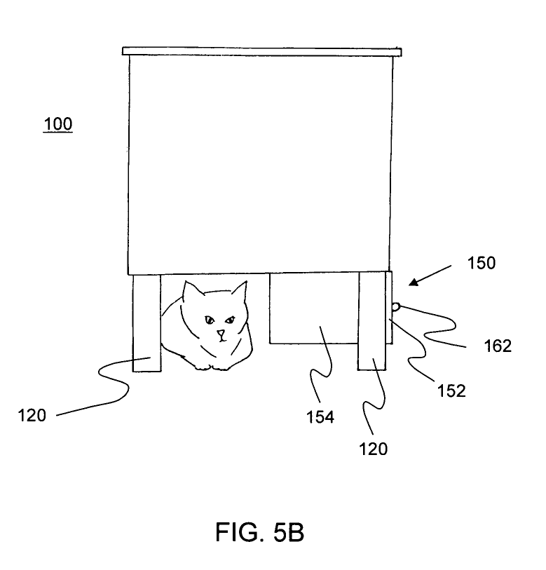

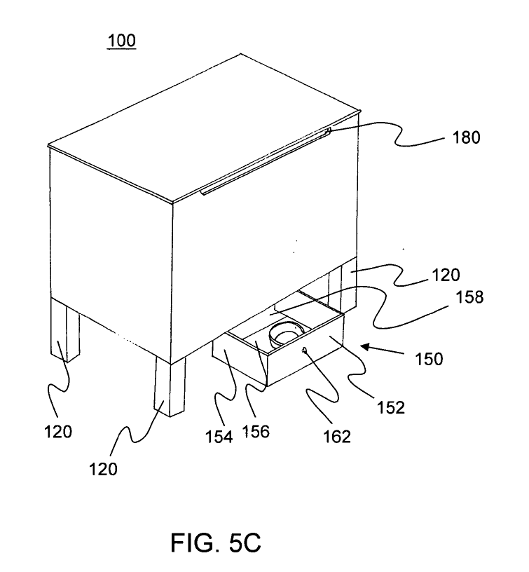

Both the freestanding and built-in versions of the enclosure with floor panel entrance 100 may be customized or built to the consumer's specifications. Both the freestanding and built-in versions may include the following optional features:
Kitten guard, a wall 140 see FIG. 3
Feeding drawer 150 see FIGS. 5A, 5B, and 5C
Entrance/exit brush or bristles 170 for trapping pet hair see FIG. 4
Ventilation hole 180 see FIGS. 5A and 5C
In addition, the cabinet may be enlarged or modified to provide extra areas for storage.

As illustrated in FIG. 3, a wall 140 may be installed on opposing side panels 116 in the cabinet interior as a kitten guard when the cabinet is used for a birthing/nursing area. The wall 140 provides a barrier between the pet entrance/exit formed by the aperture 124 and the area used for kittens, a kitten area, in the cabinet interior. The wall 140 is tall enough to prevent newborn kittens from climbing over the wall and falling out of the aperture 124 in the floor panel 118 or escaping, but the wall 140 is low enough to allow the mother cat or other small animal to enter and exit as she pleases. The wall 140 may be fixed or removable. When the wall 140 is removable it may be held in place by two opposing slotted holders 142. When the removable wall is utilized, the wall 140 can be removed when not in use. The cabinet 100 in this embodiment provides a private area for a female animal with young. The embodiment of FIG. 3 illustrates a freestanding cabinet, with a hinged 130 access door 126 in the open position, and a removable kitten guard or removable wall 140. A cat/animal occupant is shown lying on the floor panel 118, nursing a litter of kittens.

In yet another embodiment as illustrated in FIGS. 5A, 5B, and 5C, a feeding drawer 150 may be placed beneath the floor panel 118 where it will not obstruct or interfere with the pet entrance/exit. The feeding drawer 150 is smaller in length and width than the cabinet 100. It consists of a drawer front panel 152, opposing drawer side panels 154 and a dish holder 156 for food, water, or other necessities. The dish holder 156 is attached with the drawer front panel 152 and the opposing drawer side panels 154 behind the drawer front panel 152. The opposing drawer side panels 154 are attached with the drawer front panel 152. As mentioned above, the length of the drawer side panels 154 are less than the depth of the enclosure 100, so that the pet may maneuver in the space between the drawer side panel 154 and the base support structure 120 under the rear of the enclosure 100. The feeding drawer 150 is constructed like a typical dresser drawer; however, it has an open area 158 where the back panel would normally be located. Because the feeding drawer 150 does not have a back panel, the cat, pet, or other small animal may access the contents of the food/water dish holder 156 while the drawer 150 is underneath the cabinet 100 or in a closed position. The drawer 150 keeps the pet food and water hidden from the consumer's sight, and prevents larger household pets from accessing its contents. The feeding drawer 150 may be attached to the underside of the cabinet 100 or the floor panel 118 with a slide means to slide the feeding drawer 150 in and out, or the feeding drawer 150 may be unattached and positioned on the floor under the cabinet 100. The attached feeding drawer 150 may be used with a child safety latch so that young children are prevented from accessing the drawer 150 contents. The drawer 150 opens and closes easily to allow the consumer easy access to the inside compartment for maintenance of the animal's food and water. A drawer pull 162 may be attached with the drawer front panel to aid in opening and closing the drawer or pulling the drawer out from under the cabinet. FIGS. 5A and 5B show the feeding drawer 150 in the closed position. FIG. 5C shows the feeding drawer 150 in the open position.

FIG. 4 depicts a bottom view of another embodiment where the aperture 124 located in the floor panel 118, may include bristles 170. The bristles 170 may encircle the perimeter of the aperture 124, either the entire perimeter or a portion of the perimeter. The bristles 170 trap pet hair as the animal rubs across the bristles 170 when the pet passes through the entrance/exit, thus removing any loose pet hair and trapping the hair in the bristles 170.

In another embodiment similar to that illustrated in FIGS. 5A and 5C at least one ventilation aperture, hole, or opening 180 may be placed in the cabinet to allow light and air into the interior of the cabinet 100.

What is claimed is:

1. An enclosure comprising:
a floor panel attached with the lower portion of said enclosure;
a means to raise said floor panel off the ground to a height that enables a pet to maneuver beneath said floor panel; and
an aperture disposed in said floor panel by which the pet may access said enclosure.

2. An enclosure, as claimed in claim 1, wherein said enclosure is a freestanding cabinet.

3. An enclosure, as claimed in claim 2, wherein said means to raise said floor panel off the ground comprises a base support structure attached with said floor panel wherein said base support structure raises said floor panel off the ground to the height that enables the pet to maneuver beneath said floor panel.

4. An enclosure, as claimed in claim 1, wherein said enclosure is a built-in cabinet.

5. An enclosure, as claimed in claim 4, wherein said means to raise said floor panel off the ground comprises a means to attach said enclosure with a wall structure wherein said means to attach said enclosure with the wall structure raises said floor panel off the ground to the height that enables the pet to maneuver beneath said floor panel.

6. An enclosure, as claimed in claim 1, further comprising an access door attached with said enclosure by which a person may access said enclosure.

7. An enclosure, as claimed in claim 6, wherein said access door is attached by a hinged means.

8. An enclosure, as claimed in claim 6, wherein said access door is attached with a side portion of said enclosure by which the person may access said enclosure.

9. An enclosure, as claimed in claim 6, wherein said access door is attached with an upper portion of said enclosure by which the person may access said enclosure.

10. An enclosure, as claimed in claim 1, wherein said enclosure further comprises a ventilation opening.

11. An enclosure, as claimed in claim 1, further comprising:
opposing panels in the interior of said enclosure; and
a wall disposed on said opposing panels forming a kitten area, and an entrance/exit area including said aperture, wherein said wall forms a barrier between said entrance/exit area and said kitten area, wherein the height of said wall is shorter than the height of said opposing panels, wherein the height of said wall will prevent newborn kittens from falling out of said aperture in said entrance/exit area but the height of said wall will still allow a mother cat to enter and exit said kitten area.

12. An enclosure, as claimed in claim 11, wherein:
said opposing panels further comprises opposing slotted holders positioned on said opposing panels; and
said wall is removable wherein said removable wall is attached with said opposing panels by sliding said removable wall into said opposing slotted holders forming said kitten area and said entrance/exit area.

13. An enclosure, as claimed in claim 1, further comprising a feeding drawer disposed beneath said floor panel so as not to obstruct said aperture, wherein said feeding drawer comprises:
a drawer front panel;
opposing drawer side panels, wherein said opposing drawer side panels are attached with said drawer front panel and the length and width of said feeding drawer will be less than the length and width of said base support structure, so that a pet may maneuver in the space between said feeding drawer and said base support structure;
an open area on the rear portion of the feeding drawer for allowing pet access to a dish; and
a dish holder positioned between and attached with said opposing drawer side panels and said drawer front panel wherein the dish may be placed on said dish holder.

14. An enclosure, as claimed in claim 13, wherein said feeding drawer is not attached with a lower portion of the enclosure.

15. An enclosure, as claimed in claim 13, wherein said feeding drawer is attached with a lower portion of the enclosure by means of a drawer slide means and further comprising a drawer pull attached with said drawer front panel to aid in opening and closing said feeding drawer.

16. An enclosure, as claimed in claim 14, further comprising a child safety latch attached with said feeding drawer to prevent young children from accessing feeding drawer contents.

17. An enclosure as claimed in claim 1, further comprising bristles that encircle perimeter of said aperture located in said floor panel, wherein the pet rubs said bristles when the pet passes through said aperture for trapping pet hair.

18. An enclosure comprising:
a top panel;
side panels attached with said top panel;
a floor panel attached with said side panels;
a base support structure for raising said floor panel off the ground high enough to enable an average small pet such as a cat to maneuver beneath said floor panel; and
an aperture disposed in said floor panel by which the pet enters and exits said enclosure and accesses the pet related articles within said enclosure.

19. An enclosure, as claimed in claim 18, further comprising an access door attached with said side panels by which a consumer accesses the pet related articles in said enclosure.

20. An enclosure, as claimed in claim 18, further comprising a kitten guard wherein the said kitten guard comprises:
opposing slotted holders positioned adjacent each other with said side panels in an interior of said enclosure; and
a removable wall that slides into said opposing slotted holders positioned on said side panels in the interior of said enclosure, wherein said removable wall forms a barrier between pet entrance and exit and the enclosure interior, the height of said removable wall will be less than the height of said side panel, said removable wall will prevent newborn kittens from falling out of pet entrance but will still allow the mother cat to enter and exit the enclosure interior as she pleases.

21. An enclosure, as claimed in claim 18, further comprising a feeding drawer disposed beneath said floor panel so as not to obstruct said aperture, wherein said feeding drawer comprises:
a drawer front panel;
two opposing drawer side panels, said opposing drawer side panels attached with said drawer front panel wherein the length of said opposing drawer side panels will be less than the width of said side panels, so that an average small pet or cat may maneuver in the space between said opposing drawer side panels and said base support structure; and
a dish holder wherein said dish holder is positioned between and attached with said opposing drawer side panels and said drawer front panel and said dish holder acts as a tray upon which a food and water dish may be placed.
